(19) United States
(12) Patent Application Publication
(10) Pub. No.: US 2012/0003419 A1
(43) Pub. Date: Jan. 5, 2012

(54) CONVENIENTLY-HUNG TOWEL

(76) Inventor: Hua Xue, Savoy, IL (US)

(21) Appl. No.: 12/696,024

(22) Filed: Jan. 28, 2010

(30) Foreign Application Priority Data
Nov. 11, 2008 (CN) CN20082225523U

(51) Int. Cl. B32B 3/06

(52) U.S. Cl. 428/100; 428/99

(57) ABSTRACT

The present invention discloses a conveniently-hung towel comprising a towel body (1) and a hanging body (2) which is arranged on the upper end of the towel body (1), wherein a buckling device which enables the upper end and the lower end of the hanging body to be buckled together, is arranged on the hanging body (2). The towel can be hung on various handles through the buckling device, such as an oven handle, a cross bar, or an annular towel support. The towel has the characteristics of convenient use, beautiful appearance, sanitation, and low manufacturing cost.

### CROSS REFERENCE TO RELATED APPLICATIONS

This application claims the priority of Chinese Patent Application CN20082225523U filed on Nov. 11, 2008, and published as Publication Number CN201299504 on Sep. 2, 2009, which is hereby incorporated by reference in its entirety.

### BACKGROUND OF THE INVENTION

### Field of Invention

The present invention relates primarily to hanging towels from objects, including towel bars, oven handles, refrigerator handles, or other desirable locations. Having hand towels in convenient locations can often be helpful in the kitchen, bathroom, powder room, and office. When the towel gets dirty, it may be easily released from the object, then washed.

It is often difficult to keep a towel in a convenient location and users frequently do not take the time to hang the towel back on towel bars.

### SUMMARY OF THE INVENTION

When the towel is in a convenient location, it is faster to get to, and when hung down, the user can quickly locate a clean section of the towel.

In utilizing the present invention, the towel provides the benefits of being easy to clean, easy to attach to a wide range of objects, decorative, inexpensive to produce, and convenient in usage.

It is also desirable to make the button look appealing. Decorative buttons display the towel and buttons in a manner that fits the decor of many kitchens, bathrooms, powder rooms, and offices.

### BRIEF DESCRIPTION OF THE DRAWINGS

FIG. 1 is an front view of an embodiment of the present invention in an open position.

### PART NUMBERS USED IN THE DRAWINGS

1 towel
2 hanging body
3 button hole
4 attachment button

### DETAILED DESCRIPTION OF THE PREFERRED EMBODIMENTS

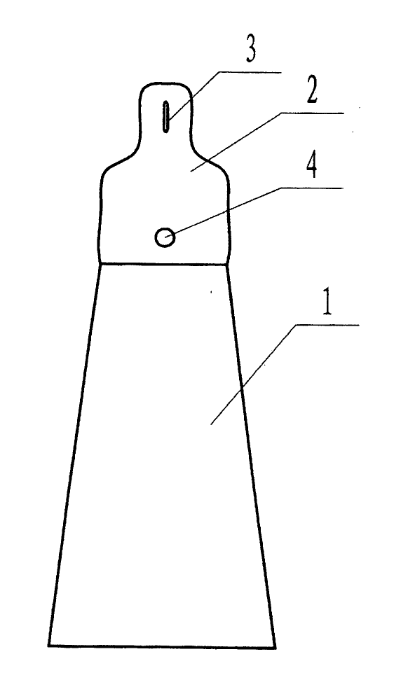

In its preferred embodiment, as shown in FIG. 1, a towel 1 is provided for wiping hands, food, or other objects. The towel 1 is attached to a hanging body 2 portion. In the preferred embodiment, the towel 1 is a terry cloth material commonly used in kitchen hand towels, and the hanging body 2 is a thicker cloth material, capable of additional resistance to pulling. The hanging body 2 may also be made from the same piece of cloth as the towel 1. It is preferred to have two different materials for the hanging body 2 and the towel 1. The two pieces may be sewn together to attach them together.

In placing the towel apparatus on an object, the user can wrap the hanging body 2 portion around the object in the desired location. The object may be a refrigerator handle, oven handle, towel bar, bathroom towel rack, sink area, ring, or many other objects capable of attaching a towel. Kitchens, bathrooms, bars, sinks, work areas, golfball washers, and any location where towels are used, may be desirable locations to have the apparatus.

To attach the towel apparatus securely to the object, the hanging body 2 is connected back onto itself by an attachment method. As shown in the FIGURE, it is preferred to provide a button hole 3 on one end and a button 4 on the opposite end of the hanging body 2. By placing the button 4 adjacent to the towel 1 portion, the user does not need to feed the hanging body 2 and button 4 together around the towel bar or object to be attached to.

The button 4 shown in the FIGURE is a standard, circular button. For decorative purposes, the button 4 may be made into a wide variety of shapes, colors, styles and materials to suit the users.

Other methods of fastening may be utilized in securing the hanging body 2 to an object. Hook and loop fasteners, snaps, buckles, or many other means can be utilized.

While the invention has been illustrated and described as embodiments of a hanging towel, accordingly it is not limited to the details shown, because it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

I claim:

1. A convenient hanging towel comprising a main towel, attached to a hanging body including means for attaching to an object.

2. The convenient hanging towel according to claim 1, wherein the means for attaching to an object comprises a button and button hole.

3. The convenient hanging towel according to claim 1, wherein the hanging body further comprises a hook and loop fastener.

4. A convenient hanging towel comprising a main towel, attached to a hanging body, further comprising a hanging section, at least one button attached to a first portion of the hanging section and at least one button hole attached to a second portion of the hanging section, such that the hanging portion may wrap around a supporting object and the button may be secured in the button hole.

5. A towel comprising a main towel section and a hanging body section, the hanging body being attached to the main towel section with a portion located near the main towel section and a portion opposite the main towel section, further comprising a button at portion and a button hole at the other portion, allowing the hanging body section to be wrapped around a bar and the button secured in the button hole, such that the towel may hang from the bar.

6. The towel according to claim 6, wherein the button is a decorative shape.
